(19) United States
(12) Patent Application Publication
(10) Pub. No.: US 2026/0131729 A1
(43) Pub. Date: May 14, 2026

(54) ACTUATOR ASSEMBLY FOR AN OUTER REAR-VIEW MIRROR, REAR VIEW MIRROR AND VEHICLE

(71) Applicant: Motherson Innovations Company Limited, London (GB)

(72) Inventors: Kyung Jun LEE, Bucheon-si (KR); Geonhwan RHEE, Bucheon-si (KR); Hongjun SONG, Bucheon-si (KR)

(21) Appl. No.: 19/300,963

(22) Filed: Aug. 15, 2025

(30) Foreign Application Priority Data
Nov. 8, 2024 (DE) 10 2024 132 658.1

(51) Int. Cl. B60R 1/072; F16H 1/30

(52) U.S. Cl. CPC B60R 1/072; F16H 1/30

(57) ABSTRACT

The present disclosure relates to an actuator assembly configured for rotating an exterior rear-view mirror, in particular a head of the exterior rear-view mirror, mounted to a vehicle, the actuator assembly comprising: at least one tilt worm gear; at least one tilt pinion gear having at least an external surface and internal surface, wherein the external surface of the tilt pinion gear meshes at least partly with the tilt worm gear; at least one tilt shaft comprising a central shaft, wherein the central shaft comprises a first end and a second end, wherein the second end of the central shaft is configured to connect to the exterior rear-view mirror, in particular its head, and the central shaft has a first axis of rotation, at least one tilt cover comprising at least a primary bore, wherein the primary bor is configured to couple at least partly with the first end of central shaft, to coincide with the first axis of rotation. The actuator assembly further comprises at least one arc-shaped member having at least an external surface, an internal surface and two end faces, wherein the external surface of the arc-shaped member is coupled at least partly with the internal surface of the tilt pinion gear, the rotation axis of the arc-shaped member and the tilt pinion gear coincides with a second axis of rotation, the at least one tilt cover comprises an auxiliary shaft, the auxiliary shaft is configured to mount the internal surface of the arc-shaped member to coincide with the second axis of rotation, and the arc-shaped member is configured to engage or disengage the tilt pinion gear with the auxiliary shaft to transmit rotational motion or stop transmission of rotational motion from the tilt pinion gear to the tilt shaft. In addition, an exterior rear view mirror and a vehicle with such an actuator assembly (100) are provided.

### CROSS-REFERENCE TO RELATED APPLICATION

This application claims priority from German Patent Application No. DE 102024132 658.1, filed November 8, 2024, the entirety of which is incorporated herein by reference.

### FIELD

The present disclosure relates to an actuator assembly for an exterior rear-view mirror. Further, the present disclosure relates to an exterior rear-view mirror with such an actuator assembly as well as to a vehicle with such an exterior rear-view mirror.

### BACKGROUND AND SUMMARY

Actuator assemblies have been used in exterior rear-view mirror for decades. An actuator assembly enables automatic folding and tilting of the exterior rear-view mirror. The actuator assembly involves multiple driving trains to achieve the automatic folding and tilting of the exterior rear-view mirror.

The existing tilting drive train involves a tilt worm gear driving a tilt pinion gear. Further, the tilt pinion gear is configured with a tilt shaft. Further, the tilt shaft is configured to connect with an exterior rear-view mirror. The existing tilting drive train comes up with a plurality of challenges. Firstly, in a scenario of over driving of the tilt worm gear to the tilt pinon gear due to motor malfunction or any similar reason, the friction and the shear stress between the tilt worm gear and the tilt pinion gear increases excessively. Secondly, in a scenario of the tilt pinion gear at an extreme position due to physical stoppage by stoppers, the driving of the tilt pinion gear by the tilt worm gear increases the friction and the shear stress excessively, due to back reaction from the stoppers. Thirdly, the manual tilting of the exterior rear-view mirror from outside results in excessive shear stress between the tilt worm gear and tilt pinion gear.

For example, US10315575B2 discloses the exterior rearview mirror system for the vehicle includes an exterior rearview mirror assembly having a mounting portion mountable at a side of a vehicle and a mirror head portion pivotally adjustable relative to the mounting portion.

JP2023000254A provides a mirror surface angle adjustment unit of the exterior rearview mirror which can increase distances that rods move forward or rearward.

US11628720B2 relates to an adjustment device for adjusting an air influencing element of a motor vehicle between at least a first position and a second position, comprising a driving unit for adjusting the air influencing element between at least the first position and the second position, provided with an input shaft and an output shaft which is at a distance from the axis of the input shaft, wherein the driving unit has a first part which is provided around the input shaft of the driving unit, and has a second part which is provided around the output shaft of the driving unit, wherein the adjustment device is furthermore provided with a failsafe mechanism, wherein the failsafe mechanism engages the first part of the driving unit.

Therefore, there is a need to develop an improved actuator assembly with reduced friction and shear stress between gear parts of the assembly leading to an improved reliability even in high stress situations..

Hence, it is an object of the present disclosure to further develop the known actuator assembly to overcome at least partly the known drawbacks of the prior art. In particular it is the object to develop an actuator assembly for an exterior rear-view mirror which reduces friction and shear stress between the tilt worm gear and the tilt pinion gear

i) in a scenario of over driving of the tilt worm gear onto the tilt pinon gear,

ii) on driving the tilt pinion gear at extreme ends, and/or

iii) on manual tilting of the exterior rear-view mirror from outside.

This object may be solved, for example, by the embodiments recited in the claims, for example, with at least one arc-shaped member having at least an external surface, an internal surface and two end faces, wherein the external surface of the arc-shaped member is coupled at least partly with the internal surface of the tilt pinion gear, the rotation axis of the arc-shaped member and the tilt pinion gear coincides with a second axis of rotation, the at least one tilt cover comprises an auxiliary shaft, the auxiliary shaft is configured to mount the internal surface of the arc-shaped member to coincide with the second axis of rotation, and the arc-shaped member is configured to engage or disengage the tilt pinion gear with the auxiliary shaft to transmit rotational motion or stop transmission of rotational motion from the tilt pinion gear to the tilt shaft.

In an aspect the arc-shaped member may comprise at least one ring spring being optionally press fitted to the tilt pinion gear, and/or the external surface of the arc-shaped member may be frictionally coupled with the internal surface of the tilt pinion gear around the second axis of rotation.

According to an embodiment the internal surface of the tilt pinion gear may comprise at least one wedge shaped member, with in particular the wedge shaped member being configured to abut at least partly against at least one of the two end faces of the arc-shaped member and/or wherein at least one gap may be provided between at least one of the two end faces of the arc-shaped member and the wedge shaped member.

It may be advantageous that the tilt worm gear may be configured to act on the tilt pinion gear to rotate the tilt shaft about the first axis of rotation, when the arc-shaped member engages the auxiliary shaft with the tilt pinion gear, and the tilt worm gear may be configured to act on the tilt pinion gear to rotate the tilt pinion gear about the second axis of rotation, when the arc-shaped member disengages the auxiliary shaft from the tilt pinion gear.

Further, it is proposed that the arc-shaped member may be elastic, wherein the elastic nature of the arc-shaped member may be configured to enable engaging or disengaging of the tilt pinion gear with the auxiliary shaft which optionally in return correspondingly enables or stops transfer of rotational motion from the tilt pinion gear to the tilt shaft.

In another aspect, when the rotational torque received by the arc-shaped member may be less than a resisting torque of the arc-shaped member, the arc-shaped member may be configured to retain its shape thereby engaging with the auxiliary shaft to enable transfer of rotational motion from the tilt pinion gear to the auxiliary shaft tilt shaft, and when the rotational torque received by the arc-shaped member may be more than the resisting torque of the arc-shaped member, the arc-shaped member may be configured to expand to disengaging with the auxiliary shaft to stop transfer of rotational motion from the tilt pinion gear to the tilt shaft.

Further, in an event of motor malfunction, when the tilt pinion gear may transmit a torque higher than the resisting torque of the arc-shaped member to the arc-shaped member, the arc-shaped member may be configured to disengage from the auxiliary shaft and the transfer of the rotational motion from the tilt pinion gear to the tilt shaft stops, such that the tilt worm gear rotates the tilt pinion gear about the second axis of rotation.

Additionally, it is proposed that the actuator assembly may comprise at least one stopper for limiting the rotation of the tilt pinion gear physically, wherein optionally two stoppers are provided at two extreme ends or positions.

In an embodiment, when the tilt pinion gear may be at extreme ends of the tilt worm gear, the reaction force from the stopper(s) may cause the amount of torque reaching the arc-shaped member to exceed the resisting torque of the arc-shaped member, such that the arc-shaped member may disengage from the auxiliary shaft, the transfer of the rotational motion from the tilt pinion gear to the tilt shaft may stop, and the tilt worm gear may rotate the tilt pinion gear about the second axis of rotation.

In another embodiment, the central shaft may comprise a plurality of protrusions, and the tilt cover may comprise a plurality of cut-outs which is optionally configured to couple correspondingly at least partly with the plurality of protrusions.

It may be advantageous that the tilt shaft may further comprise an extended arm, wherein optionally the extended arm may comprise a primary shaft, and the auxiliary shaft may comprise a secondary bore which is configured to couple with the primary shaft.

Further, a tensioner may be placed between the two end faces and the wedge shaped member, wherein optionally the tensioner may be configured to secure the arc-shaped member with the tilt pinion gear.

In another aspect, the tensioner may comprise at least one hole and/or at least one clip, and/or the tensioner may be made of high carbon steel material and/or may be a U-shaped element.

According to an embodiment, the wedge shaped member may comprise at least one pin member and/or at least one recess.

It is further proposed, that the at least one pin member of the wedge shaped member may fit correspondingly into the at least one hole of the tensioner, and/or the at least one clip of the tensioner may fit correspondingly into the at least one recess of the wedge shaped member.

In another aspect the tilt shaft may further comprise at least one side wall guide, and the tilt cover may comprise a seating surface configured to receive at least partly the side wall guide.

In another embodiment, the tilt shaft may further comprise at least one raised surface having at least one orifice for applying synthetic oil to lubricate the tilt pinion gear, and/or the tilt cover further comprising at least one protruding seat surface with at least one orifice for applying synthetic oil to lubricate the tilt pinion gear.

According to embodiments of the present disclosure an exterior rear view mirror is provided having at least one actuator assembly as disclosed above.

In an embodiment, when the exterior rear-view mirror may be tilted from outside, intending the tilt pinion gear to drive back the tilt worm gear, and the rotating torque may exceed the resisting torque of the arc-shaped member, the arc-shaped member may be configured to disengage from the auxiliary shaft, such that the transfer of the rotational motion from the tilt shaft to the tilt pinion gear may stop.

According to embodiments of the present disclosure a vehicle is provided having at least one actuator assembly as disclosed above and/or exterior rear view mirror as disclosed above.

Accordingly, an aspect of present disclosure relates to an actuator assembly for an exterior rear-view mirror, the actuator assembly comprising: a tilt worm gear; a tilt pinion gear having an external surface and internal surface, wherein the external surface of the tilt pinion gear meshes with the tilt worm gear; -an arc-shaped member having an external surface, internal surface and two end faces, wherein the external surface of the arc-shaped member is coupled with the internal surface of the tilt pinion gear around a second axis of rotation; and a tilt shaft comprising a central shaft, wherein the central shaft comprises a first end and a second end, wherein the second end of the central shaft is configured to connect to the exterior rear-view mirror, and the central shaft has a first axis of rotation, a tilt cover comprising a primary bore and an auxiliary shaft, wherein the primary bore is configured to couple with the first end of central shaft around the first axis of rotation, and the auxiliary shaft is configured to mount the internal surface of the arc-shaped member around the second axis of rotation, wherein the arc-shaped member is configured to engage / disengage the tilt pinion gear with the auxiliary shaft to transmit / stop rotational motion from the tilt pinion gear to the tilt shaft.

In an embodiment of the present disclosure, the internal surface of the tilt pinion gear may comprise a wedge shaped member, wherein the wedge shaped member is configured to abut against at least one of the two end faces of the arc-shaped member.

In an embodiment of the present disclosure, the tilt worm gear may be configured to drive the tilt pinion gear about the first axis of rotation of the tilt shaft when the arc-shaped member engages the auxiliary shaft with the tilt pinion gear.

In an embodiment of the present disclosure, the tilt worm gear may be configured to rotate the tilt pinion gear about the second axis of rotation when the arc-shaped member disengages the auxiliary shaft from the tilt pinion gear.

In an embodiment of the present disclosure, the central shaft may comprise a plurality of protrusions, and wherein the tilt cover comprises a plurality of cut-outs which is configured to couple correspondingly with the plurality of protrusions.

In an embodiment of the present disclosure, the tilt shaft further may comprise an extended arm, wherein the extended arm comprises a primary shaft, and wherein the auxiliary shaft comprises a secondary bore which is configured to couple with the primary shaft.

In an embodiment of the present disclosure, the wedge shaped member may comprise at least one pin member and at least one recess.

In an embodiment of the present disclosure the assembly may further comprise a tensioner placed between the two end faces and the wedge shaped member.

In an embodiment of the present disclosure, the tensioner may comprise at least one hole and at least one clip.

In an embodiment of the present disclosure, the at least one pin member of the wedge shaped member may fit correspondingly into the at least one hole of the tensioner, wherein the at least one clip of the tensioner fits correspondingly into the at least one recess of the wedge shaped member.

In an embodiment of the present disclosure, the tilt shaft may further comprise a side wall guide, and the tilt cover comprises a seating surface configured to receive the side wall guide.

In an embodiment of the present disclosure, the tilt shaft may further comprise a raised surface having at least one orifice for applying synthetic oil to lubricate the tilt pinion gear.

In an embodiment of the present disclosure, the tilt cover may further comprise a protruding seat surface with at least one orifice for applying synthetic oil to lubricate the tilt pinion gear.

In an embodiment of the present disclosure, the arc-shaped member may be elastic in nature.

### BRIEF DESCRIPTION OF THE DRAWINGS

It should be noted that the features set out individually in the following description can be combined with each other in any technically advantageous manner and set out other forms of the present disclosure. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number. The description further characterizes and specifies the present disclosure in particular in connection with the Figures.

Other aspects, advantages, and salient features of the present disclosure will become apparent to those skilled in the art from the following detailed description, which taken in conjunction with the annexed drawings, discloses exemplary embodiments of the disclosure, wherein:

FIG. 1 shows a perspective view of a vehicle with an exterior rear-view mirror in accordance with an embodiment of the present disclosure.

FIG. 2 shows a perspective view of an actuator assembly with a mirror base of the exterior rear-view mirror in accordance with an embodiment of the present disclosure.

FIG. 3 shows a perspective view of the actuator assembly of FIG. 2.

FIG. 4 shows an exploded view of the actuator assembly of FIG. 2, excluding a tilt worm gear.

FIG. 5 shows another exploded view of the actuator assembly, from a different perspective compared to FIG. 4.

FIG. 6a shows a perspective view of a tilt pinion gear of the actuator assembly of FIG. 2.

FIG. 6b shows a perspective view of the tilt pinion gear of the actuator assembly of FIG. 2, coupled with an arc-shaped member.

FIG. 7a shows a perspective view of the arc-shaped member of FIG. 6b.

FIG. 7b shows a perspective view of normal and expanded configuration of the arc-shaped member of FIG. 7b, with an auxiliary shaft.

FIG. 8 shows a perspective view of the tilt shaft of the actuator assembly of FIG. 2.

FIG. 9 shows a perspective view of a tilt cover along with the arc-shaped member and the tilt pinion gear of the actuator assembly of FIG. 2.

FIGS. 10a and 10b show perspective views of the tilt pinion gear of the actuator assembly of FIG. 2, at extreme ends in mesh with a tilt worm gear.

FIGS. 11a and 11b show different perspective views of a tensioner of the actuator assembly of FIG. 2.

FIG. 12 shows a perspective view of the tensioner and the tilt pinion gear of the actuator assembly of FIG. 2.

### DETAILED DESCRIPTION

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, the same reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “exterior”, “inner”, “left”, “right”, “vertical”, “horizontal”, etc. may relate to one or more particular components as seen generally from a user’s vantage point during use or operation, and such terms and/or phrases are not to be interpreted as limiting, but merely as a representative basis for describing the disclosure to one skilled in the art. In addition, a suffix "region", "part", "unit" for a component used in the following description are given or mixed in consideration of only the ease of writing the specification, and do not have meanings or roles distinguished from each other.

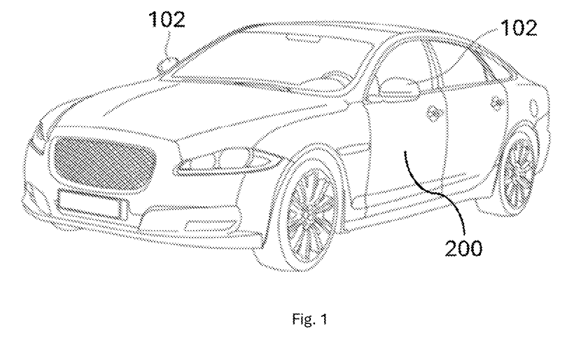

FIG. 1 shows a schematic view of a vehicle 200 in accordance with an embodiment of the present disclosure. The vehicle 200 referred to herein embodies a four-wheeled vehicle. Alternatively, the vehicle 200 may embody other vehicles, such as two-wheeled vehicles, three-wheeled vehicles, six-wheeled vehicles, eight-wheeled vehicles, all-terrain vehicles ATVs, etc., without limiting the scope of the disclosure. FIG. 1 also shows two exterior rear-view mirrors 102 configured on the vehicle 200, one exterior rea-view mirror 102 mounted on each side of the vehicle 200.

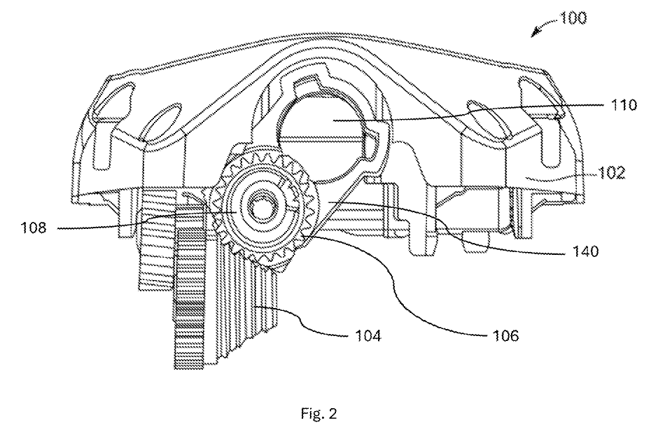

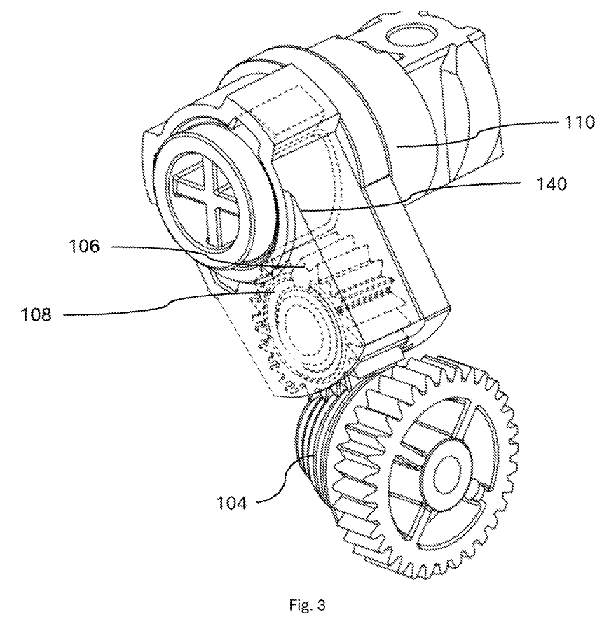

FIG. 2 shows a perspective view of an actuator assembly 100 with a mirror base of the exterior rear-view mirror 102. FIG. 3 shows a perspective view of the actuator assembly 100. As shown in FIGS. 2 and 3, the actuator assembly 100 encompasses a tilt worm gear 104, a tilt pinion gear 106, an arc-shaped member 108, a tilt shaft 110 and a tilt cover 140.

The actuator assembly 100 may be configured inside a casing of the exterior rear-view mirror 102, i.e. the housing of the mirror head to be moved relative to the mirror base via the actuator assembly. In detail, the actuator assembly 100 is at least configured to allow tilting movement of the head of the exterior rear-view mirror 102 for adjusting a field of view provided to a driver of the vehicle 200 via each one of the two rear-view mirrors 102.

The tilt worm gear 104 is configured to receive torque from a power source (not shown). In an embodiment, the tilt worm gear 104 may receive the torque through a drive train from the power source. The tilt worm gear 104 may be a stepped cone gear. Further, the tilt worm gear 104 may be meshed with the tilt pinion gear 106 in order to transmit the received torque to the tilt pinion gear 106. The combination of the tilt worm gear 104 and the tilt pinion gear 106 acts as a reduction gear assembly, wherein the tilt worm gear 104 acts as a driver and the tilt pinion gear 106 acts as a driven gear. Furthermore, the rotation of the tilt pinion gear 106 may be physically limited by placing one or more stoppers, in particular two stoppers (not shown) at two extreme ends or positions. The implementation of said stopper(s) lies within the knowledge of a person skilled in the art.

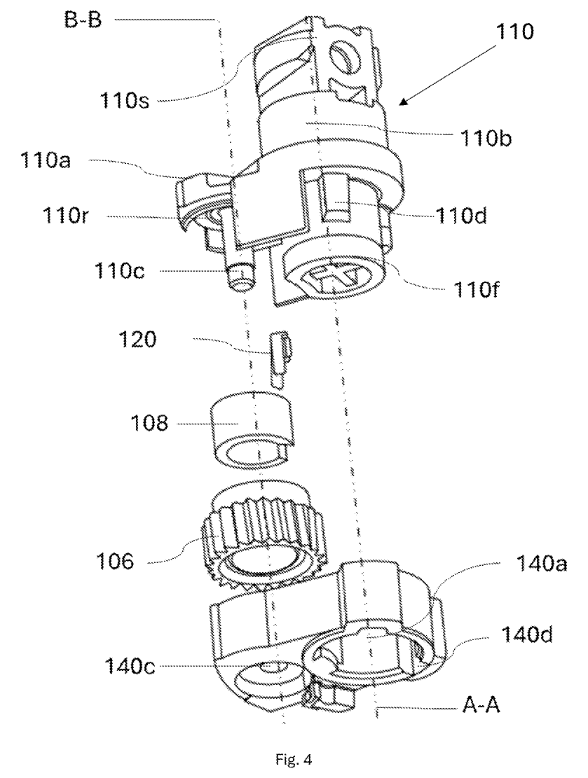

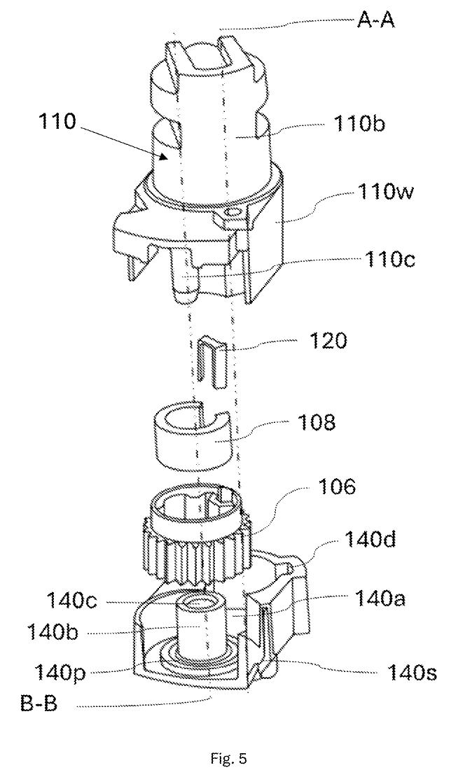

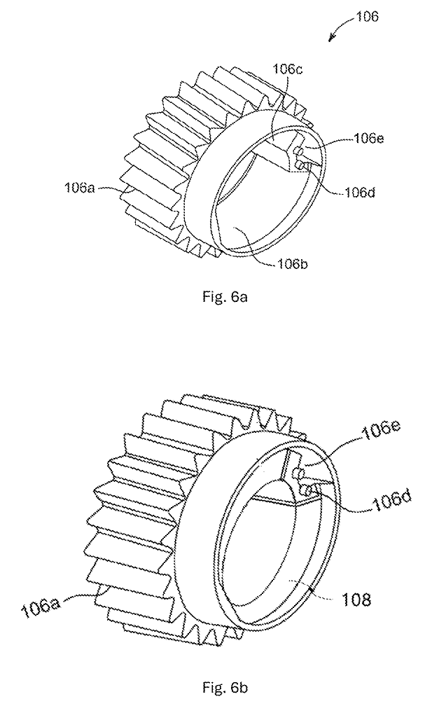

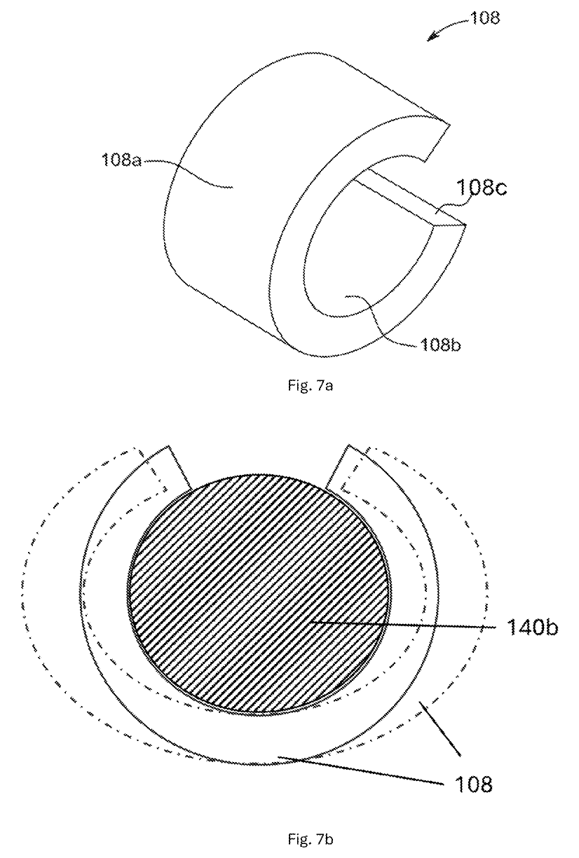

FIGS. 4 and 5 each show an exploded views of the actuator assembly 100 (excluding the tilt worm gear 104), from two different perspectives. The actuator assembly 100, as shown in FIGS. 4 and 5, illustrates the tilt pinion gear 106, the arc-shaped member 108, the tilt shaft 110, the tilt cover 140, and a tensioner 120. The tilt pion gear 106 is connected to the tilt cover 140 via the arc-shaped member 108 along a second axis of rotation B-B. Optionally, the tensioner 120 may be placed between two end faces 108c (see FIG. 7a) of the arc-shaped member 108 and wedge shaped member 106c (see FIG. 6a) of the tilt pinion gear 106. Further, the tilt cover 140 is connected to the tilt shaft 110 along a first axis of rotation A-A.

The tilt pinion gear 106, as shown in FIG. 6a, may have an external surface 106a and an internal surface 106b. The tilt pinion gear 106 may be made-up of a polymer material. In an embodiment, the tilt pinion gear 106 may be made-up of PA6 CF30. The external surface 106a of the tilt pinion gear 106 may be geared and meshed with the tilt worm gear 104. The internal surface 106b may comprise a wedge shaped member 106c. The wedge shaped member 106c may rise from the internal surface 106b. Further, the wedge shaped member 106c may comprise at least one pin member 106d and at least one recess 106e.

Further, as shown in FIG. 6b, the tilt pinion gear 106 may be frictionally coupled with the arc-shaped member 108. The arc shaped member 108 may be a ring spring and press fitted to the tilt pinion gear 106. Thereby, the external surface 108a of the arc-shaped member 108 may be frictionally coupled with the internal surface 106b of the tilt pinion gear 106. Further, there may be a gap between at least one end of the arc shaped member 108 and the wedge shaped member 106c. The gap may increase depending on the usage conditions such as number of adjustments, temperature and humidity environment of use and/or assembly tolerance. Backlash occurs due to the clearance when the ring spring overrides, and free play occurs when the mechanism is configured by driving and adjusting the tilt axle. Gear backlash may occur during deceleration of the tilt pinion gear and tilt worm gear 104. In an embodiment, due to the ring spring's tightening force, clearance management is required to cope with e.g. thermal expansion or contraction of the ring spring.

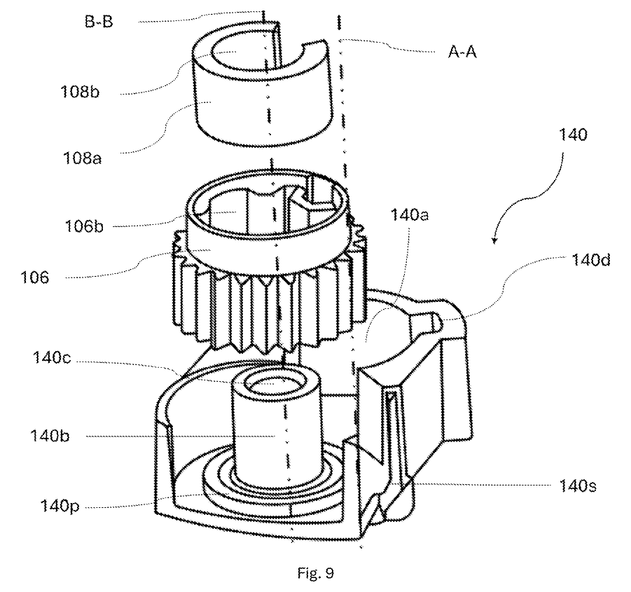

As shown in FIG. 7a, the arc-shaped member 108 may have an external surface 108a, an internal surface 108b and two end faces 108c. The arc-shaped member 108 may be a C-shaped member. The arc-shaped member 108 may be made up of an elastic material bearing elastic properties facilitating engaging or disengaging an auxiliary shaft 140b as indicated in FIG. 7b. In an embodiment, the arc-shaped member 108 may be made up of SK5 material. The external surface 108a of the arc-shaped member 108 may be frictionally coupled with the internal surface 106b of the tilt pinion gear 106 around a second axis of rotation B-B, as shown in FIG. 9.

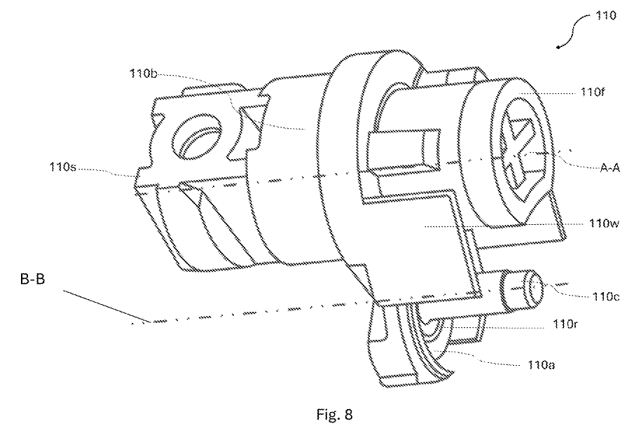

Further, as shown in FIG. 8, the tilt shaft 110 may have a central shaft 110b and an extended arm 110a. The central shaft 110b may have a first axis of rotation A-A. Further, the central shaft 110b may comprise a plurality of protrusions 110d. The central shaft 110b may have a first end 110f and a second end 110s. The second end 110s may be configured to connect to the not shown head of the exterior rear-view mirror 102. Further, the extended arm 110a may have a primary shaft 110c. The tilt shaft 110 may be made up of a polymer material. In an embodiment, the tilt shaft 110 may be made up of PA6 GF50 material. The tilt shaft 110 may also have a side wall guide 110w. Further, the tilt shaft 110 also comprise a raised surface 110r having at least orifice for applying synthetic oil to lubricate the tilt pinion gear 106. Further, the first end 110f of the central shaft 110b may be coupled with the tilt cover 140.

Further, as shown in FIG. 9, the tilt cover 140 may have a primary bore 140a (also shown in FIG. 4) and the auxiliary shaft 140b. The tilt cover 140 may be made up of a polymer material. In an embodiment, the tilt cover 140 may be made up of a PA6 GF65 material. The tilt cover 140 may comprise a plurality of cut-outs 140d which may be configured to couple correspondingly with the plurality of protrusions 110d of the central shaft 110b of the tilt shaft 110 (as shown in FIG. 4). The tilt cover 140 may also comprise a protruding seat surface 140p with at least one orifice for applying synthetic oil to lubricate the tilt pinion gear 106. Further, the tilt cover 140 may comprise a seating surface 140s configured to receive the side wall guide 110w of the tilt shaft 110 (as shown in FIG. 5). The primary bore 140a may be configured to couple with the first end 110f of central shaft 110b around the first axis of rotation A-A. The auxiliary shaft 140b may have a secondary bore 140c which may be configured to couple with the primary shaft 110c. Further, the auxiliary shaft 140b may be configured to co-axially mount the arch-shaped member 108 and the tilt pinion gear 106. The auxiliary shaft 140b may be configured to mount the internal surface 108b of the arc-shaped member 108 around the second axis of rotation B-B. Further, the external surface 108a of the arc-shaped member 108 may be frictionally coupled with the internal surface 106b of the tilt pinion gear 106 around the second axis of rotation B-B. Further, the at least one of the two end faces 108c of the arc-shaped member 108 may be configured to abut against the wedge shaped member 106c of the tilt pinion gear 106.

The elastic nature of the arc-shaped member 108 enables engaging or disengaging of the tilt pinion gear 106 with the auxiliary shaft 140b which in return correspondingly enables or stops transfer of rotational motion from the tilt pinion gear 106 to the tilt shaft 110. As shown in FIG. 7b with solid lines, the rotational torque received by the arc-shaped member 108 is less than the resisting torque of the arc-shaped member 108, the arc-shaped member 108 is configured to retain its shape thereby engaging with the auxiliary shaft 140b to enable transfer of rotational motion from the tilt pinion gear 106 to the auxiliary shaft tilt shaft 110. However, in an event of the rotational torque received by the arc-shaped member 108 is more than the resisting torque of the arc-shaped member 108, the arc-shaped member 108 is configured to expand as shown in FIG. 7b, shown with dotted lines, and thereby disengaging with the auxiliary shaft 140b to stop transfer of rotational motion from the tilt pinion gear 106 to the tilt shaft 110.

As shown in FIGS. 2 and 3, the tilt worm gear 104 may drive the tilt pinion gear 106 to revolute about the first axis of rotation A-A of the tilt shaft 110 when the arc-shaped member 108 engages the auxiliary shaft 140b with the tilt pinion gear 106. In an event of motor malfunction, the tilt pinion gear 106 may transmit a torque, higher than the resisting torque of the arc-shaped member 108, to the arc-shaped member 108. This may result in disengaging of the arc-shaped member 108 with the auxiliary shaft 140b and the stoppage of transfer of the rotational motion from the tilt pinion gear 106 to the tilt shaft 110. This may cause the tilt worm gear 104 to rotate the tilt pinion gear 106 about the second axis of rotation B-B. This may also result in reduction of friction and shear stress between the tilt worm gear 104 and the tilt pinion gear 106.

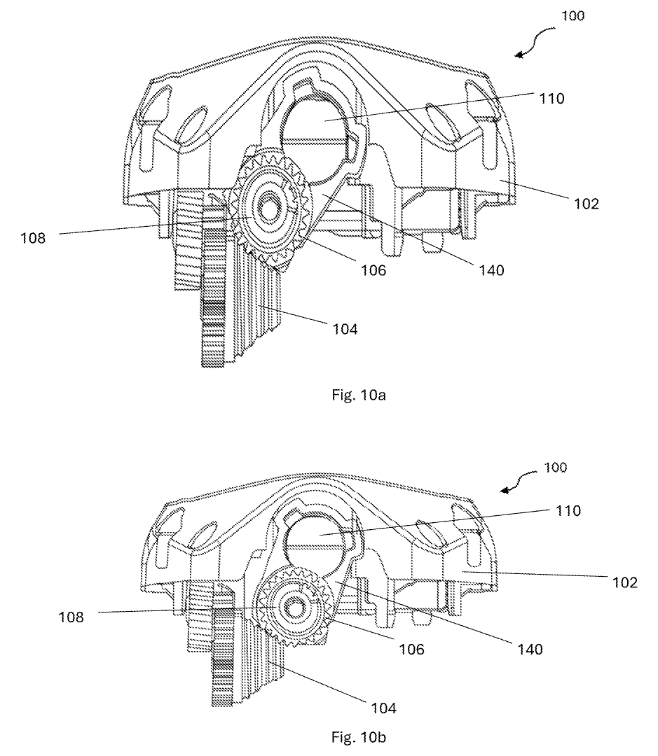

In another embodiment, wherein the tilt pinion gear 106 is at extreme ends of the tilt worm gear 104 as shown in FIGS. 10a and 10b, the reaction force from the stopper may cause the amount of torque reaching the arc-shaped member 108 exceed the resisting torque of the arc-shaped member 108. This may result in disengaging of the arc-shaped member 108 with the auxiliary shaft 140b and the stoppage of transfer rotational motion from the tilt pinion gear 106 to the tilt shaft 140. This may cause the tilt worm gear 104 to rotate the tilt pinion gear 106 about the second axis of rotation B-B. This may also result in reduction of friction between the tilt worm gear 104 and the tilt pinion gear 106 caused due to back reaction.

In yet another embodiment, wherein the exterior rear-view mirror 102 may be tilted from outside, intending the tilt pinion gear 106 to drive back the tilt worm gear 104. This attempt of reverse rotation in the reduction gear assembly of the tilt worm gear 104 and the tilt pinion gear 106 may cause a rotating torque exceeding the resisting torque of the arc-shaped member 108. This may result in disengaging of the arc-shaped member 108 with the auxiliary shaft 140b and the stoppage of transfer of the rotational motion from the tilt shaft 140 to the tilt pinion gear 106. This may also lead to the reduction of shear stress between the tilt worm gear 104 and the tilt pinion gear 106.

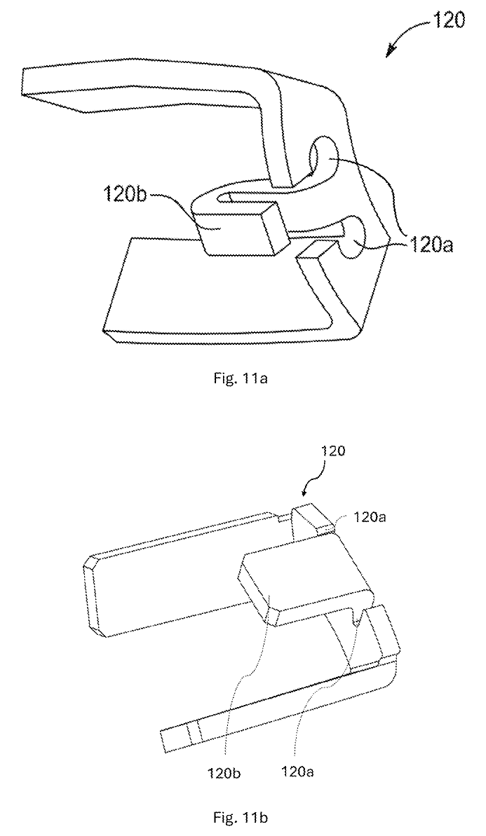

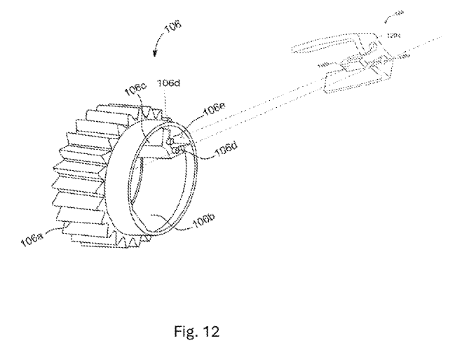

In yet another embodiment, the actuator assembly 100 may comprise of a tensioner 120 as shown in FIGS. 11a and 11b. The tensioner 120 may be placed between the two end faces 108c of the arc-shaped member 108 and the wedge shaped member 106c. The tensioner 120 may tightly secure the arc-shaped member 108 with the tilt pinion gear 106. Further, the tensioner 120 may comprise at least one hole 120a and at least one clip 120b. Further, as shown in FIG. 12, the at least one hole 120a of the tensioner 120 may correspondingly couple with the at least one pin member 106d of the wedge shaped member 106c. Similarly, as shown in FIG. 12, the at least one clip 120b of the tensioner 120 may correspondingly be inserted into the at least one recess 106e of the wedge shaped member 106c. The tensioner 120 may be made of high carbon steel material. In an embodiment, the tensioner 120 may be made up of SK5 material. In an embodiment, the tensioner 120 may be a U-shaped element.

In the following some embodiments of the present disclosure are briefly described:

### Embodiment 1:

An actuator assembly 100 for an exterior rear-view mirror 102, the actuator assembly 100 comprising: a tilt worm gear 104; a tilt pinion gear 106 having an external surface 106a and internal surface 106b, wherein the external surface 106a of the tilt pinion gear 106 meshes with the tilt worm gear 104; an arc-shaped member 108 having an external surface 108a, an internal surface 108b and two end faces 108c, wherein the external surface 108a of the arc-shaped member 108 is coupled with the internal surface 106b of the tilt pinion gear 106 around a second axis of rotation B-B; and a tilt shaft 110 comprising a central shaft 110b, wherein the central shaft 110b comprises a first end 110f and a second end 110s, wherein the second end 110s of the central shaft 110b is configured to connect to the exterior rear-view mirror 102, and the central shaft 110b has a first axis of rotation A-A, a tilt cover 140 comprising a primary bore 140a and an auxiliary shaft 140B, wherein the primary bore 140a is configured to couple with the first end 110f of central shaft 110b around the first axis of rotation A-A, and the auxiliary shaft 140b is configured to mount the internal surface 108b of the arc-shaped member 108 around the second axis of rotation B-B, wherein the arc-shaped member 108 is configured to engage / disengage the tilt pinion gear 106 with the auxiliary shaft 140b to transmit / stop rotational motion from the tilt pinion gear 106 to the tilt shaft 110.

### Embodiment 2:

The internal surface 106b of the tilt pinion gear 106 comprises a wedge shaped member 106c, wherein the wedge shaped member 106c is configured to abut against at least one of the two end faces 108c of the arc-shaped member 108.

### Embodiment 3:

The tilt worm gear 104 is configured to drive the tilt pinion gear 106 about the first axis of rotation A-A of the tilt shaft 110 when the arc-shaped member 108 engages the auxiliary shaft 140b with the tilt pinion gear 106.

### Embodiment 4:

The tilt worm gear 104 is configured to rotate the tilt pinion gear 106 about the second axis of rotation B-B when the arc-shaped member 108 disengages the auxiliary shaft 140b from the tilt pinion gear 106.

### Embodiment 5:

The central shaft 110b comprises a plurality of protrusions 110d, and wherein the tilt cover 140 comprises a plurality of cut-outs 140d which is configured to couple correspondingly with the plurality of protrusions 110d.

### Embodiment 6:

The tilt shaft 110 further comprises an extended arm 110a, wherein the extended arm 110a comprises a primary shaft 110c, and wherein the auxiliary shaft 140b comprises a secondary bore 140c which is configured to couple with the primary shaft 110c.

### Embodiment 7:

The wedge shaped member 106c comprises at least one pin member 106d and at least one recess 106e.

### Embodiment 8:

The actuator assembly 100 further comprises a tensioner 120 placed between the two end faces 108c and the wedge shaped member 106c.

### Embodiment 9:

The tensioner 120 comprises at least one hole 120a and at least one clip 120b.

### Embodiment 10:

The at least one pin member 106d of the wedge shaped member 106c fits correspondingly into the at least one hole 120a of the tensioner 120, wherein the at least one clip 120b of the tensioner 120 fits correspondingly into the at least one recess 106e of the wedge shaped member 106c.

### Embodiment 11:

The tilt shaft 110 further comprises a side wall guide 110w, and the tilt cover 140 comprises a seating surface 140s configured to receive the side wall guide 110w.

### Embodiment 12:

The tilt shaft 110 further comprises a raised surface 110r having at least one orifice for applying synthetic oil to lubricate the tilt pinion gear 106.

### Embodiment 13:

The tilt cover 140 further comprising protruding seat surface 140p with at least one orifice for applying synthetic oil to lubricate the tilt pinion gear 106.

### Embodiment 14:

The arc-shaped member 108 is elastic in nature.

### Embodiment 15:

A vehicle 200 having an actuator assembly 100 according to any of the previous embodiments.

Therefore, the present disclosure provides an actuator assembly for an exterior rear-view mirror which reduces friction and shear stress between the tilt worm gear and the tilt pinion gear in a scenario of over driving of the tilt worm gear to the tilt pinon gear. The present disclosure also provides an actuator assembly for an exterior rear-view mirror which reduces friction and shear stress between the tilt worm gear and the tilt pinion gear on driving the tilt pinion gear at extreme ends. The present disclosure also provides an actuator assembly for an exterior rear-view mirror which reduces shear stress between the tilt worm gear and the tilt pinion gear on manual tilting from outside.

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims, i.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

### REFERENCE SIGN LIST

100 actuator assembly

102 exterior rear-view mirror

104 tilt worm gear

106 tilt pinion gear

106a external surface

106b internal surface

106c wedge shaped member

106d pin member

106e recess

108 arc-shaped member

108a external surface

108b internal surface

108c end face

110 tilt shaft

110a extended arm

110b central shaft

110c primary shaft

110d plurality of protrusions

110f first end

110r raised surface

110s second end

110w side wall guide

120 tensioner

120a hole

120b clip

140 tilt cover

140a primary bore

140b auxiliary shaft

140c secondary bore

140d plurality of cut-outs

140s seating surface

140p protruding seat surface

200 vehicle

A-A first axis of rotation

B-B second axis of rotation

1. An actuator assembly configured for rotating a head of an exterior rear-view mirror mounted to a vehicle, the actuator assembly comprising:
at least one tilt worm gear;
at least one tilt pinion gear having at least an external surface and an internal surface, wherein the external surface of the tilt pinion gear meshes at least partly with the tilt worm gear;
at least one tilt shaft comprising a central shaft, wherein the central shaft comprises a first end and a second end, wherein the second end of the central shaft is configured to connect to the head of the exterior rear-view mirror, and the central shaft has a first axis of rotation;
at least one tilt cover comprising at least a primary bore, wherein the primary bore is configured to couple at least partly with the first end of central shaft to coincide with the first axis of rotation; and
at least one arc-shaped member having at least an external surface, an internal surface, and two end faces, wherein
the external surface of the arc-shaped member is coupled at least partly with the internal surface of the tilt pinion gear,
the rotation axis of the arc-shaped member and the tilt pinion gear coincides with a second axis of rotation,
the at least one tilt cover comprises an auxiliary shaft,
the auxiliary shaft is configured to mount the internal surface of the arc-shaped member to coincide with the second axis of rotation, and
the arc-shaped member is configured to engage or disengage the tilt pinion gear with the auxiliary shaft to transmit rotational motion or stop transmission of rotational motion from the tilt pinion gear to the tilt shaft.

2. The actuator assembly according to claim 1, wherein
the arc-shaped member comprises at least one ring spring being press fitted to the tilt pinion gear, and/or
the external surface of the arc-shaped member is frictionally coupled with the internal surface of the tilt pinion gear around the second axis of rotation.

3. The actuator assembly according to claim 1, wherein
the internal surface of the tilt pinion gear comprises at least one wedge shaped member, with the wedge shaped member being configured to abut at least partly against at least one of the two end faces of the arc-shaped member, and/or
at least one gap is provided between at least one of the two end faces of the arc-shaped member and the wedge shaped member.

4. The actuator assembly according to claim 1, wherein
the tilt worm gear is configured to act on the tilt pinion gear to rotate the tilt shaft about the first axis of rotation when the arc-shaped member engages the auxiliary shaft with the tilt pinion gear, and
the tilt worm gear is configured to act on the tilt pinion gear to rotate the tilt pinion gear about the second axis of rotation, when the arc-shaped member disengages the auxiliary shaft from the tilt pinion gear.

5. The actuator assembly according to claim 1, wherein the arc-shaped member is elastic, and wherein the elastic nature of the arc-shaped member is configured to enable engaging or disengaging of the tilt pinion gear with the auxiliary shaft which in return correspondingly enables or stops transfer of rotational motion from the tilt pinion gear to the tilt shaft.

6. The actuator assembly according to claim 5, wherein
when the rotational torque received by the arc-shaped member is less than a resisting torque of the arc-shaped member, the arc-shaped member is configured to retain its shape thereby engaging with the auxiliary shaft to enable transfer of rotational motion from the tilt pinion gear to the auxiliary shaft tilt shaft, and
when the rotational torque received by the arc-shaped member is more than the resisting torque of the arc-shaped member, the arc-shaped member is configured to expand to disengaging with the auxiliary shaft to stop transfer of rotational motion from the tilt pinion gear to the tilt shaft.

7. The actuator assembly according to claim 1, wherein
the central shaft comprises a plurality of protrusions, and
the tilt cover comprises a plurality of cut-outs which is configured to couple correspondingly at least partly with the plurality of protrusions.

8. The actuator assembly according to claim 1, wherein the tilt shaft further comprises an extended arm, and wherein the extended arm comprises a primary shaft, and the auxiliary shaft comprises a secondary bore which is configured to couple with the primary shaft.

9. The actuator assembly according to claim 3, comprising a tensioner between the two end faces and the wedge shaped member, wherein the tensioner is configured to secure the arc-shaped member with the tilt pinion gear.

10. The actuator assembly accordingclaim 9, wherein
the tensioner comprises at least one hole and/or at least one clip, and/or
the tensioner is made of high carbon steel material and/or is a U-shaped element.

11. The actuator assembly according to claim 3, wherein the wedge shaped member comprises at least one pin member and/or at least one recess.

12. The actuator assembly according claim 11, wherein
the at least one pin member of the wedge shaped member fits correspondingly into the at least one hole of the tensioner (120), and/or
the at least one clip of the tensioner fits correspondingly into the at least one recess of the wedge shaped member.

13. The actuator assembly according to claim 1, wherein
the tilt shaft further comprises at least one side wall guide, and
the tilt cover comprises a seating surface configured to receive at least partly the side wall guide.

14. The actuator assembly according to claim 1, wherein
the tilt shaft further comprises at least one raised surface having at least one orifice for applying synthetic oil to lubricate the tilt pinion gear, and/or
the tilt cover further comprising at least one protruding seat surface with at least one orifice for applying synthetic oil to lubricate the tilt pinion gear.

15. An exterior rear view mirror having at least one actuator assembly according to claim 1.

16. The exterior rear view mirror according to claim 15, wherein when the exterior rear-view mirror is tilted from outside, intending the tilt pinion gear to drive back the tilt worm gear, and the rotating torque exceeds the resisting torque of the arc-shaped member, the arc-shaped member is configured to disengage from the auxiliary shaft, such that the transfer of the rotational motion from the tilt shaft to the tilt pinion gear stops.

17. A vehicle having at least one actuator assembly according to claim 1.

18. A vehicle having at least one exterior rear view mirror according to claim 15.
